(19) United States
(12) Patent Application Publication
(10) Pub. No.: US 2001/0029607 A1
(43) Pub. Date: Oct. 11, 2001

(54) System and method for application installation management

(75) Inventors: James E. Veres, Woodinville, WA (US); Luis M. Huapaya, Bellevue, WA (US); Scott R. Leatham, Duvall, WA (US); Richard C.H. Granshaw, Sammamish, WA (US); Joseph Chauvin, Sammamish, WA (US); Jonathan Hildebrandt, Redmond, WA (US)

Correspondence Address: John E. McGlynn, Esquire, WOODCOCK WASHBURN KURTZ, MACKIEWICZ & NORRIS LLP, One Liberty Place - 46th Floor, Philadelphia, PA, 19103, US

(73) Assignee: Microsoft Corporation

(21) Appl. No.: 09/843,199

(22) Filed: Apr. 26, 2001

Related U.S. Application Data
(63) Continuation-in-part of application No. 09/491,156, filed on Jan. 26, 2000.
(60) Provisional application No. 60/127,921, filed on Apr. 6, 1999.
(60) Provisional application No. 60/202,993, filed on May 10, 2000.

(51) Int. Cl. G06F 9/455

(52) U.S. Cl. 717/11

(57) ABSTRACT

An application manager and application programming interface (API) for managing an install operation, a downsize operation, a reinstall operation, and an uninstall operation are disclosed. A method of communicating between the application manager and an application to perform these operations comprises the following steps: receiving from the application a call to set a property related to performing an application installation operation; receiving from the application a call to initialize an application installation operation; and receiving from the application a call to finalize the application installation operation.

### CROSS REFERENCE TO RELATED APPLICATIONS

The present patent application relates by subject matter to U.S. Provisional Patent Application Ser. No. 60/202,993, filed May 10, 2000, entitled “Client API for Managing Application Installation/Downsizing/Up-Sizing and Removal From the Hard Drive” the contents of which are hereby incorporated by reference in their entirety.

The present application further relates by subject matter to, and is a continuation-in-part of U.S. patent application Ser. No. 09/491,156, filed Jan. 26, 2000, entitled “Method and System for Managing Data in Computer Memory,” which claims priority to U.S. Provisional Patent Application Ser. No. 60/127,921, filed Apr. 6, 1999, entitled “Game Installation Management,” the contents of both of which are hereby incorporated by reference in their entirety.

### TECHNICAL FIELD

The present invention relates generally to computer systems, and more particularly to systems and methods for managing the installation of software applications.

### BACKGROUND OF THE INVENTION

It is often the case that data objects occupy space in a computer memory, even when there is no immediate need for a computer system to retrieve them from the memory. These data objects take up space that could otherwise be used by new data. It is desirable for the computer system employing the memory to remove from the memory data that is not presently being used, in order to make room for new data.

A hard disk on a personal computer is an example of a memory that may become filled with data objects, such as application programs or databases. Game applications, in particular, are exemplary of the type of data objects that present the problem addressed herein, because their usage pattern is often characterized by an initial period of frequent use (i.e., when the user has just purchased the game and is interested in playing it), followed by a period of infrequent use or non-use (when the user has won the game or lost interest in the game). These game applications tend to accumulate and can lead to large amounts of disk space being consumed by applications that may never be used again. To maintain on a hard disk a data object that the user will never use is wasteful of space, and, assuming that it can be determined that the data object will not be used again, the data object may be removed entirely from the hard disk.

When a computer system attempts to place new data in a memory such as a hard disk (e.g., where a user installs a new application on the disk) and there is not sufficient space for the new data, either data already stored on the disk must be removed from the disk to make room for the new data, or additional memory must be added, or both. In order to create space on the disk, the user may examine the contents of the disk and selectively remove data for which there is no foreseeable need (e.g., by uninstalling applications, by deleting files, etc.). This method, however, places a burden on the user, as the user must interrupt what he is doing and manually select data to be removed. Moreover, the user may predict incorrectly which data objects will not be used in the future. If a removed data object is needed in the future, the user must reinstall it from a secondary source, such as a CD-ROM or a network server; if there is no secondary source containing the data, then the removed data cannot be replaced. Additionally, there may be data objects for which some of the data comprising the objects can be recreated from a secondary source, but some data cannot be recreated. It is burdensome, and sometimes not possible, to select recreateable portions of a data object for removal (e.g., bitmap images for use with a game application), while preserving non-recreateable data (e.g., user high score, or saved game files).

In view of the foregoing, there is a need for a system for managing the installation of data objects and, in particular, software applications. Further, there is a need for a means for data objects to interface with the system for managing the installation of applications.

### SUMMARY OF THE INVENTION

Briefly, the present invention provides an application manager for controlling various operations related to the installation of data objects. According to one aspect of the invention, an application programming interface (API) is provided which allows data objects, such as software applications to interface with the application manager.

Generally, the application manager controls operations related to the installation of data objects on a computer system. In particular, the application manager manages the following operations: install, downsize, reinstall, and uninstall. The application manager relies upon the data objects to physically implement each of the installation operations but directs the data objects with respect to which operations should be performed and when the operations should be performed.

The application manager operates on a notify-and-commit procedure with respect to the four installation operations. Accordingly, prior to executing one of the installation operations, a data object must notify the application manager of the impending operation. Furthermore, after completing the installation operation, the application finalizes the operation by committing it with the application manager.

The first installation operation, install, involves the loading of a complete and operable set of data object files from an external source into memory. Example data objects include application programs (where the executable files, video files, bitmap images, etc.), and databases (where the parts may include: files of data, some of which have been archived elsewhere; a directory for the data; etc.). The application manager interacts through the application manager API with data objects which request to be installed. A data object which requests to be installed must provide the application manager with information about itself including the name of the software manufacturer and the estimated size of the files to be installed. Using the estimated file size, the application manager determines whether enough storage capacity is available to load the files. If the application manager determines that there is not enough storage space available, it may conduct a downsize operation as explained below, to free up space. Thereafter, the data object that has requested to be installed will be provided, upon request, with a location in storage at which it is to save its files. When the data object has completed installing its files at the location directed by the application manager, it notifies the application manager that the install operation is complete.

The second installation operation, “downsize,” involves removing data from memory in a manner that does not preclude use of the data object that comprises the data. The purpose of the “downsize” operation is to reduce the space occupied by a data object in a memory in order to free up space for new data. Thus, the application manager, upon receiving a request from a data object to be installed, may require a data object already loaded in memory to undergo a downsize operation in order to release storage space for the new data object.

When a data object receives a request from the application manager to perform a downsize operation, the data object provides the application manager, using the API, with the unique identifier that was assigned to the data object during the install operation. The data object notifies the application manager that the downsize operation is pending and thereafter performs the actual downsize operation. When the downsize operation is finished, the data object finalizes the downsize operation by notifying the application manager that the operation is complete.

Thus, data objects and not the application manager are responsible for implementing the downsize operation. Because software vendors are responsible for implementing the downsize operation, the downsize operations can be designed to be compatible with the operation of the particular data object. Software vendors are, therefore, free to give consideration to the specific data that the object comprises, the importance of the data for the object's function, and whether the data can be recovered from another source if necessary. The downsize operation for a given data object may reduce the size of the data object by removing non-essential data. The downsize operation may also reduce the size of the object by removing data that can be recreated from another source if necessary.

An example data object may be a software application residing on a hard disk. If a user needs additional space on the disk (e.g., to install a new application), the application manager might select an application that has not been used for a long period of time and call the application's downsize operation to create more space. A downsize operation provided with the application might remove non-essential data, such as the data file for an introductory video tour of the software, which the user has already viewed by the software owner. The downsize operation might also remove data that can easily be recovered from the application's CD-ROM, such as executable files or bitmap images used by the software. In designating recoverable data to delete, the downsize operation may be designed to consider the ease with which the data can be recovered. For example, the downsize operation may remove data that can be reloaded quickly from a CD-ROM, but not data that must be recovered from a server by way of a slow dial-up connection. The downsize operation may also leave on the hard disk data associated with the data object that cannot be recreated from another source. In the example, such data might include user-created files, a file of system-dependent parameters, or a file of user preferences that were provided by the user at the time the application was installed. The downsize operation may remove different amounts of data based on input from the system specifying how much memory the system needs (e.g., the downsize operation first deletes information that can be recovered quickly from a CD-ROM, but will also delete information that must be recovered from a slow dial-up connection if necessary to satisfy the system's space request). Each application provides a downsize operation appropriate for the type of data associated with the application.

The invention also contemplates a “reinstall” operation which replaces data that has been removed by a prior downsize operation. While a data object may provide a downsize operation without a reinstall operation, providing a reinstall operation allows the data object to provide a more effective downsize operation. Specifically, providing a reinstall operation with a downsize operation allows for the removal of essential data that can be recreated from another source (e.g., executable files residing on a CD-ROM, database files that have been archived to a tape, etc.), rather than merely nonessential data (e.g., an introductory video tour of an application, etc.). If a user later attempts to access a downsized data object, the application manager calls the data object's reinstall operation, which reloads data from a secondary source (e.g., a CD-ROM).

The application manager also contemplates an uninstall operation. The uninstall operation removes all of the files associated with the particular data object and is initiated only upon user request. A data object notifies the application manager of the impending uninstall operation and thereafter performs the uninstall. When the uninstall operation is complete, the data object finalizes the uninstall operation by notifying the application manager that the operation is complete.

Game software installed on a hard disk exemplifies a use of the system. Games typically obey a usage pattern characterized by a period of intense use when the game is new, followed by infrequent use or non-use after the user has won the game or lost interest in the game. Much of the data associated with a game application (e.g., executable files, bitmap images, etc.) is typically copied to a computer system's hard disk from a CD-ROM at the time the game is installed, and can be copied to the hard disk again if it is needed subsequent to being removed. If a user needs more space on the disk, a system embodying the invention could select, for example, the least recently played game application and call the game's downsize operation. The downsize operation could delete all executable files and bitmap images that had been copied to the hard disk from a CD-ROM at install time, leaving on the disk a file containing the user's high scores for the game. If the user subsequently reacquires an interest in the game and attempts to run it, the system calls the restore operation to replace the removed data to the disk (e.g., from a CD-ROM, prompting the user to insert the CD-ROM, if necessary). If there is not enough space on the disk to reinstall the data, the system selects another game application to downsize and calls that application's downsize operation prior to restoring the data to the disk.

Other features of the invention are described below.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram representing a computer system in which aspects of the invention may be incorporated;

FIG. 2 is a diagram of a computer memory device with which aspects of the invention may be used;

FIG. 3 is a block diagram showing the detail of a data object for use with an application manager in accordance with aspects of the invention;

FIG. 4 is a block diagram showing the use of downsize operations by an application manager, in accordance with aspects of the invention;

FIG. 5 is a flowchart showing the steps taken by an application manager to process a request for space in accordance with aspects of the invention;

FIG. 6 is a block diagram showing the use of a restore operation by an application manager, in accordance with aspects of the invention;

FIG. 7 is a flowchart showing the steps used to start an application residing on a memory that has been managed in accordance with aspects of the invention;

FIG. 8 is a flowchart of a process for communicating between the application manager and a data object during an installation operation;

FIG. 9 is a flowchart of a process for communicating between the application manager and a data object during an install operation;

FIG. 10 is a flowchart of a process for communicating between the application manager and a data object during a downsize operation;

FIG. 11 is a flowchart of a process for communicating between the application manager and a data object during a reinstall operation; and

FIG. 12 is a flowchart of a process for communicating between the application manager and a data object during an uninstall operation.

### DETAILED DESCRIPTION OF THE INVENTION

Overview

Software is often purchased to fill a short-term need such as, for example, a seasonal tax-preparation software package, or a game application that the user plays for only a few weeks or months. Long after these applications have served their purpose to the user, they continue to occupy space on a computer hard disk. An application manager in accordance with an aspect of the invention can be used to free up space occupied by such an application, while allowing the application to be reinstalled to a usable state if the user should decide to run the application again in the future. Generally, the application manager controls or manages at least four installation related operations: install; downsize; reinstall; and uninstall. An application programming interface (API) in accordance with another aspect of the invention provides a means for applications to communicate with the application manager to perform these operations.

Computer Environment

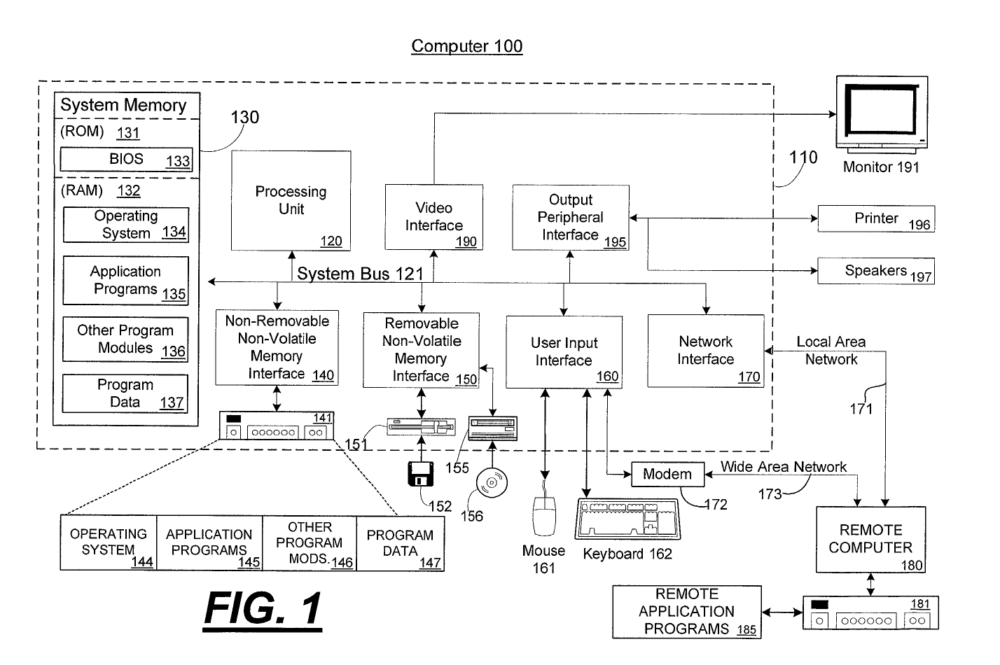

FIG. 1 illustrates an example of a suitable computing system environment 100 in which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 1³⁰, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, PAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Memory Management

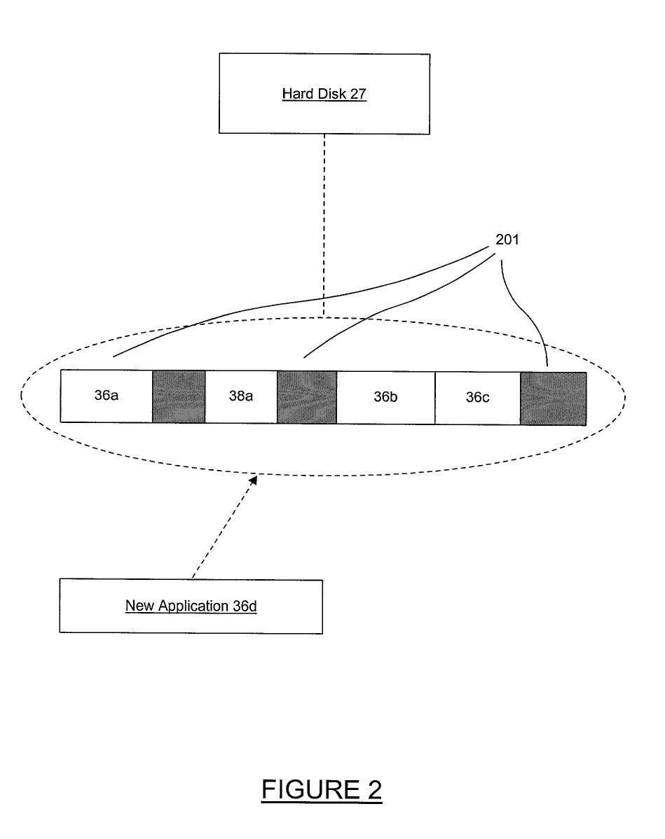

FIG. 2 shows an exemplary computer memory, hard disk 27, which contains various data objects for use with computer 20. Data objects residing on hard disk 27 include application programs 36a, 36b, and 36c, and program data 38a. Hard drive 27 also has empty space 201, which may be a contiguous space, or may be scattered in between data objects, as shown in FIG. 2. A user may want to install a new data object on hard disk 27, such as application program 36d. New application program 36d, however, may be too large to fit in empty space 201 on hard disk 27. An application manager in accordance with the invention can be used find additional space on hard disk 27 in which application program 36d may be installed. The application manager finds additional space by calling for data objects on hard disk 27, such as applications 36a, 36b, and 36c, to be downsized.

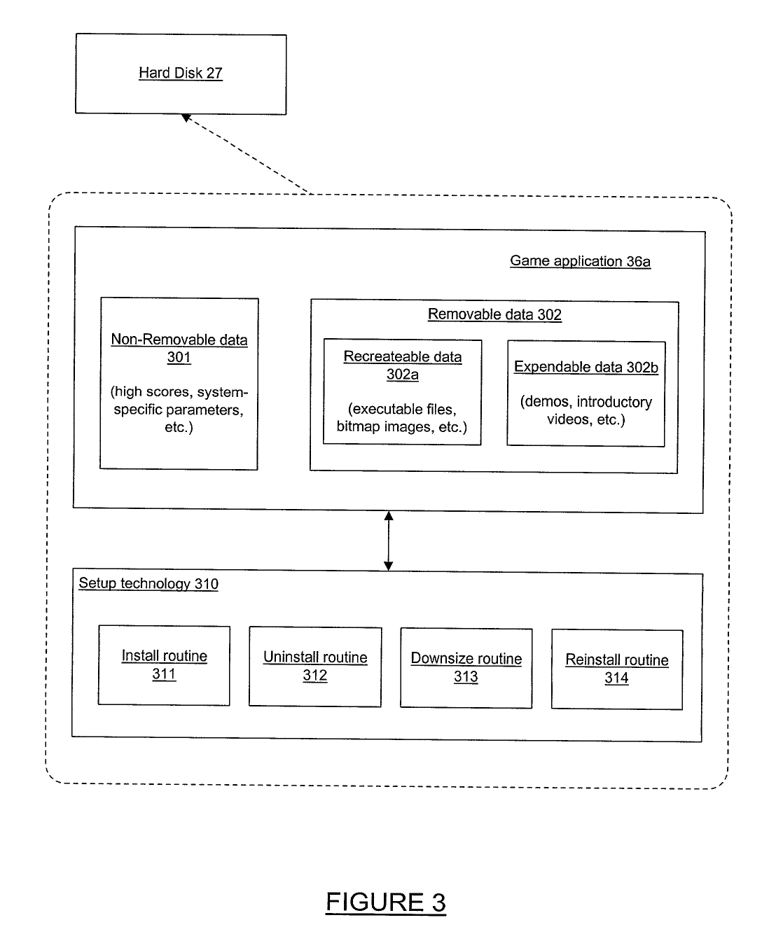

FIG. 3 shows the detail of game application 36a, which is a typical data object residing in a computer memory such as hard disk 27. Game application 36a contains non-removable data 301. In the case of a game application, non-removable data 301 could include a record of the user's high scores, hardware-specific parameters such as the type of graphics card installed on the system, user preferences that were configured by the user at the time that game application 36a was installed, or other types of data that cannot easily be recreated from a source such as a CD-ROM. For another type of data object, such as a database, non-removable data might include the database directory and data files that have not been archived. Game application 36a also contains removable data 302. Removable data 302 includes recreatable data 302a and expendable data 302b. Recreateable data 302a may include executable files, fixed program data such as bitmaps, or other data that can easily be retrieved or reconstructed from a source, such as a CD-ROM. In the example where the data object is a database, recreateable data could include archived data files that can be retrieved from a tape. Expendable data 302b includes data which is not necessary for the normal operation of application program 36a. In the case where the data object is a game application, examples of such data might include a game demo that the user has already played, or an introductory video that the user has already seen.

Game application 36a is also associated with setup technology 310. A setup technology is particular to the data object with which it is associated. In FIG. 3, setup technology 310 is the setup technology for game application 36a. Setup technology 310 includes an install routine 311, and uninstall routine 312, a downsize routine 313, and a reinstall routine 314. An install routine 311 contains computer-executable instructions to install a data object, such as game application 36a, in a memory device, such as hard disk 27. An uninstall routine 312 contains instructions to remove a data object, such as game application 36a, from the device on which it has been installed. A downsize routine 313 contains instructions to remove some data associated with a data object from the device to which it has been installed. For example, downsize routine 313 may remove recreateable data 302a and expendable data 302b from the device to which game application 36a has been installed. A reinstall routine 314 replaces in a memory device some or all of the data removed from a data object by the data object's associated downsize routine 313. Setup technology 310 may reside on the same memory device as game application 36a, as shown in FIG. 3, or it may reside in another location accessible to computer 20, such as on another disk drive (not shown), or on remote computer 49. Each data object provides its own setup technology, which provides the particular steps necessary to install, uninstall, downsize, and reinstall the data object. Ideally, the setup technology has been designed to take advantage of the particular nature of the data comprising the data object with which it is associated; for example, the downsize routine 313 contained in setup technology 310 may remove executable files from hard disk 27, and restore routine 314 may replace those files to hard disk 27 from a CD-ROM. As an alternative example, a setup technology associated with a database could include a downsize routine that keeps track of which files have been archived and removes only archived files.

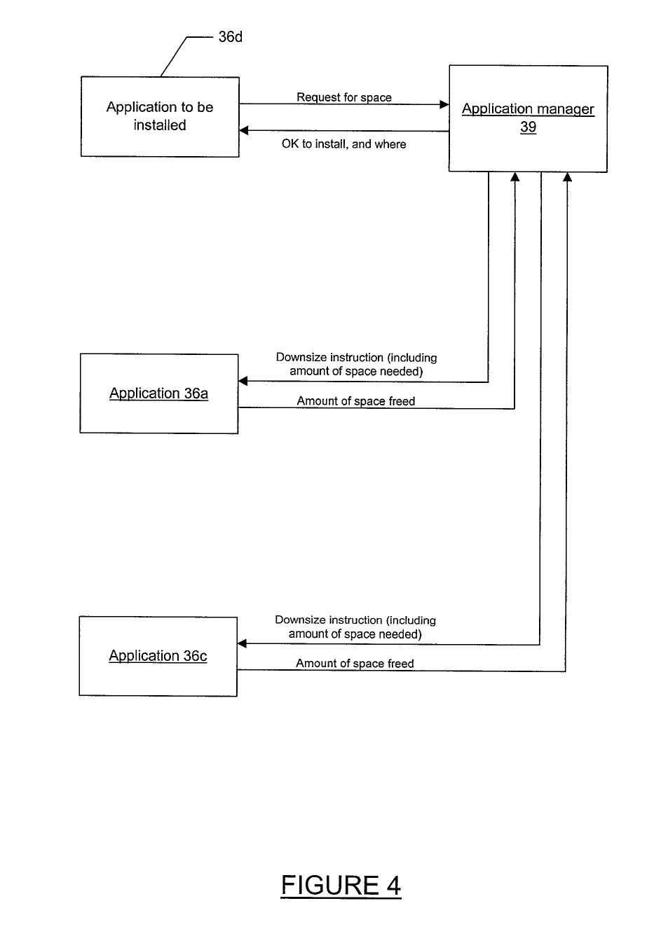

FIG. 4 shows an exemplary use of a system embodying the invention. The example system, application manager 39, manages storage space occupied by application programs by downsizing existing applications when a user attempts to write new data, such as application program 36d, to a storage medium, such as hard disk 27, on which insufficient free space exists. The invention could also be embodied in a system that manages other types of data on other types of storage media; for example, a database manager could downsize a database (e.g., by deleting archived data files) when an attempt is made to write new data to the primary storage medium and there is insufficient space for the new data.

In the example depicted in FIG. 4, a user begins the process of installing application program 36d by running the install routine for application program 36d. The install routine requests from application manager 39 space to install application program 36d and notifies application manager 39 of the amount of space needed. Application manager 39 may be integrated into operating system 35, in which case the install routine requests space from the operation system, which uses application manager 39 to obtain the space. Alternatively, application manager 39 may be a stand-alone software module that operates outside of operating system 35, in which case the install routine for application 36d requests the space directly from application manager 39. FIG. 4 depicts an implementation in which space is requested directly from application manager 39.

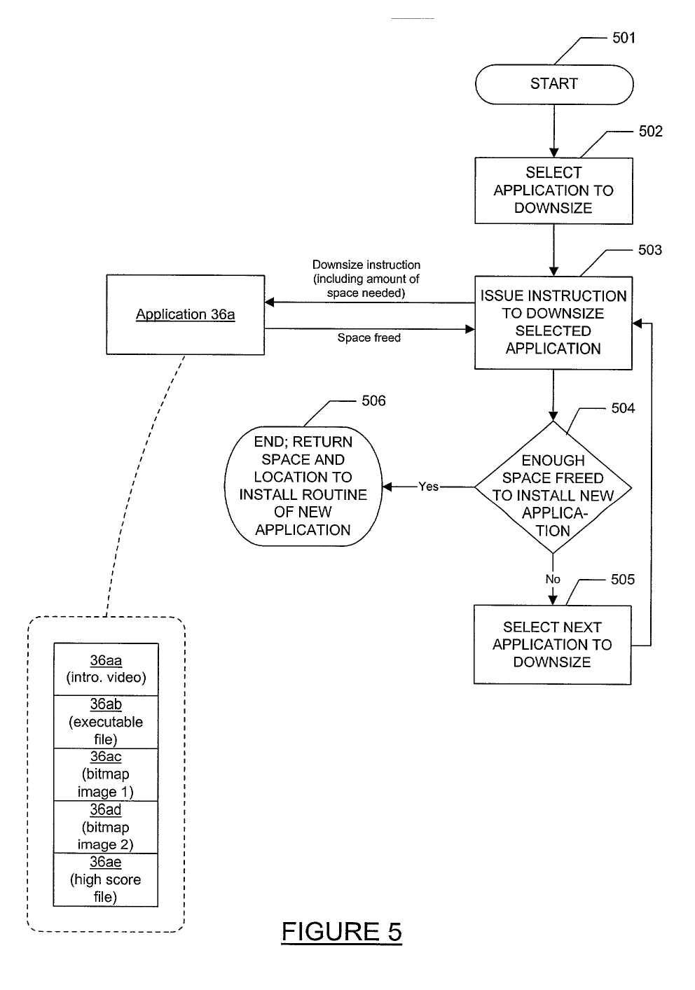

In order to create space to install application program 36d, application manager 39 first selects an application to downsize, such as application program 36a, and attempts to downsize the selected application. Possible criteria upon which application program 36a is selected for downsizing are discussed below in the text accompanying FIG. 5. The downsizing is performed by calling the downsize routine associated with application 36a. Preferably, application manager 39 informs the downsize routine associated with application 36a of the amount of space that it is looking for in order to satisfy the installation space requirements of application program 36d, and the downsize routine can free up large or small amounts of space depending upon what is needed. The downsize routine for application program 36a frees up space, and notifies application manager 39 of the amount of space freed. Application manager 39 determines whether this space is sufficient to install application program 36d. If there is sufficient space, application manager 39 notifies the install routine of application program 36d that there is sufficient space to install application program 36d and of the location of the space. If there is not sufficient space to install application program 36d, then application manager 39 issues another downsize instruction by calling the downsize routine associated with a different application program. For example, in FIG. 4, application manager 39 next calls the downsize routine for application program 36b, which then notifies application manager 39 of the amount of space freed up. This process is repeated, preferably by calling downsize routines for different applications, until sufficient space has been freed. Application manager 39 then notifies the install routine of application program 36d of the location of the space, and the install routine proceeds to install application program 36d on hard drive 27.

Application manager 39 may manage the space on a single memory device, such as hard disk drive 27. Alternatively, application manager 39 may manage space on several memory devices, such as a group of several hard disk drives. If application manager 39 manages several devices, it provides space to a requesting install routine on one or more of the devices, based on various criteria. For example, application manager 39 may provide space on the first device on which it is able to locate space; or, each application may provide its type (e.g., game, office suite, etc.) to application manager 39, which then assigns space based on the type of the application to be installed (e.g., all game applications could be installed on the first disk drive). In the present example and those which follow, application manager 39 manages space only on a single device, hard disk drive 27.

FIG. 5 is a flowchart showing the steps by which application manager 39 processes a request for more space. Application manager 39 begins the process of obtaining space to install an application, such as application 36d, in response to the request of the application's install routine. The process of obtaining space begins at step 501. At step 502, application manager 39 selects a data object to downsize, such as application 36a. The data object to downsize may be selected based on a variety of factors, such as a historical record of the number of times that the data object has been downsized or restored. Application manager 39 could also take into account the amount of time that it will take to install an application. The amount of time may be supplied with the data object, or it may be estimated by application manager 39 based on the amount of data to be retrieved and the relevant data transfer rate (e.g., the number of bytes per second that can be retrieved from the data source, such as a CD-ROM drive or a T1 connection to the Internet).

After selecting a data object to downsize, such as application program 36a, application manager 39 issues an instruction to downsize the selected data object at step 503, preferably informing the downsize routine for application 36a of the amount of space that application manager 39 needs. The is downsize routine associated with application 36a returns to application manager 39 the amount of space that it has freed. At step 504, application manager 39 determines whether it has freed sufficient space to satisfy the request for space. If it has not freed sufficient space, then it again selects a data object to be downsized at step 505, and returns to step 503 to issue a downsize instruction to that data object. Once sufficient space has been freed, application manager 39 terminates the processing of a request for space at step 506, and provides the amount and location of available space to the routine that requested the space.

When application manager 39 selects the next data object to be downsized at step 505, it may select a data object that has never been downsized, or it may select a previously downsized data object. The potential for obtaining additional space from a downsized application is due to the possibility that a downsized application may have been only partially downsized the last time its downsize routine was invoked. For example, application manager 39 may have previously installed a small application and, in the process of doing so, asked the downsize routine for application 36a to provide only a small amount of space, which did not require the downsize routine to remove all of the data that it could have removed. By way of illustration, in FIG. 5 application 36a comprises portions 36aa, 36ab, 36ac, 36ad, and 36ae. Portion 36aa is expendable data, such as a 2 megabyte introductory video. Portion 36ab is a 1.5 megabyte executable file that can be recovered from CDROM. Portions 36ac and 36ad are each 2 megabytes in size and comprise recoverable data, such as bitmap images of which copies resides on a CD-ROM. Portion 36ae includes 1 megabyte of non-removable data, such as a user high-score file. A request to downsize application 36a (e.g., generated by an attempt to install a new application) might indicate that only 3 megabytes of space were needed, so the downsize routine removes only portions 36aa and 36ab. A second request (e.g., generated as a result of an attempt to install a second new application) might call for an additional 2 megabytes of space, so the downsize routine removes portion 36ac. A third request might call for 10 megabytes of space. In this case, the downsize routine can do no more than remove portion 36ad, which frees an additional 2 megabytes of space. Portion 36ae contains non-recoverable high scores, so the downsize routine will not remove it; the downsize routine simply informs application manager 39 that it has freed 2 megabytes of space, so application manager 39 must choose another data object to downsize. Any further call to the downsize routine for application 36a will result in a notification to application manager 39 that no additional space can be freed (unless application 36a has undergone a “restore” operation since the last call to its downsize routine, as discussed below).

After a data object has been downsized, a user may attempt to use the data object again. A data object may provide a reinstall routine, which replaces some or all of the data that was removed by a downsize routine. It is not necessary for a data object to provide a reinstall routine, as a downsize routine could be limited to removing expendable data. However, a data object that provides a reinstall routine may have a more effective downsize routine, as the downsize routine would be able to delete recreateable data in addition to expendable data, because the recreateable data could be replaced by the restore routine after it has been removed.

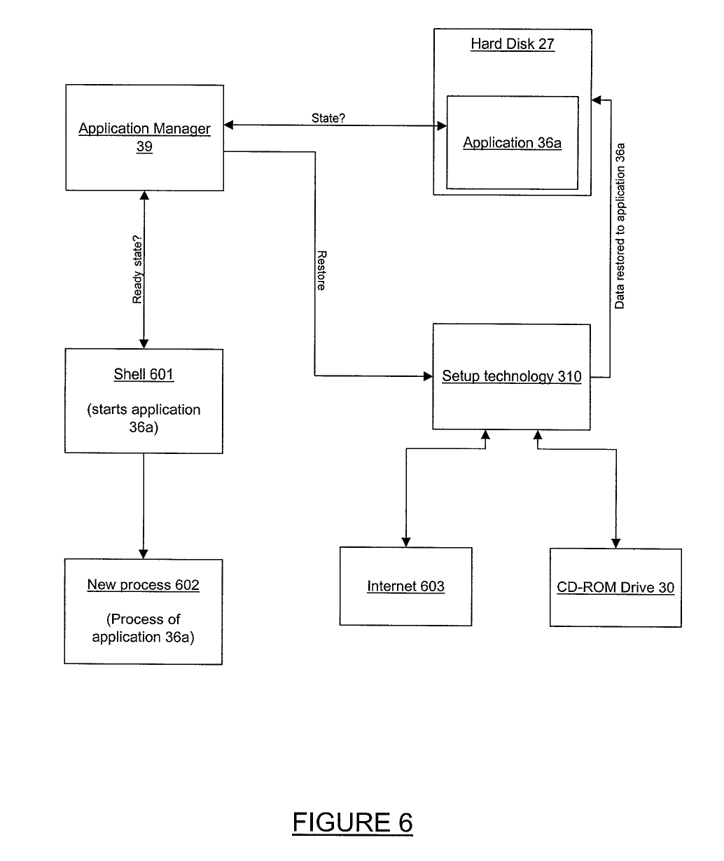

FIG. 6 illustrates the use of a reinstall routine by an example system embodying the invention, such as application manager 39. In the example, the data object to be reinstalled is application program 36a, whose data is called for as a result of attempting to start application program 36a. Shell 601 receives an instruction to start application program 36a. The instruction may come from a user, or it may come from a component of the computer system 20, such as operating system 35. Prior to creating a process for application 36a, shell 601 checks with application manager 39 to determine whether application 36a is in its “ready” state —i.e., a state in which the application program is ready to begin execution. Each data object being managed defines its own ready state and reports its current state to application manager 39. For example, application 36a could define its ready state as the state in which the application would exist immediately following installation. A data object, such as an application, may have several ready states, as it may not be necessary for the entire data object to reside on the medium in order for the data object to be ready to use. For example, application 36a may be in its ready state even if introductory videos are not present on hard disk 27; or, application 36a may have a smaller-size ready state, in which low-resolution bitmap images for use with the application are stored instead of memory-intensive high-resolution images.

Upon being queried as to whether application 36a is in its ready state, application manager 39 retrieves this information, which may be stored in a location associated with application manager 39, such as a registry, or may be stored on hard disk 27 as part of application 36a in a location accessible to application manager 39. If application manager 39 determines that application 36a is in its ready state, it notifies shell 601 of this fact, and shell 601, in turn, creates a process 602 to run application 36a.

If application 36a is not in its ready state, application manager 39 instructs the setup technology 310 associated with application 36a to reinstall application 36a to its ready state on its resident memory device, such as hard disk 27. Setup technology 310 uses reinstall routine 314 to retrieve the necessary data from its source, such as optical disk 30, or the Internet 603. If necessary, the user is prompted to insert a removable medium such as CD-ROM 31 into a disk drive, such as optical drive 30. Setup technology 310 replaces the retrieved data to hard disk 27. Setup technology 310 may replace all removed data, or it may replace only the data necessary for application 36a to run. For example, data previously removed by downsize routine 313 may include expendable data 302b, such as an introductory video, which might not be replaced by the restore routine. After replacing data to hard disk 27, setup technology 310 informs application manager 39 that application 36a is in its ready state. Application manager 39, in turn, notifies shell 601, which creates a process 602 to run application 36a.

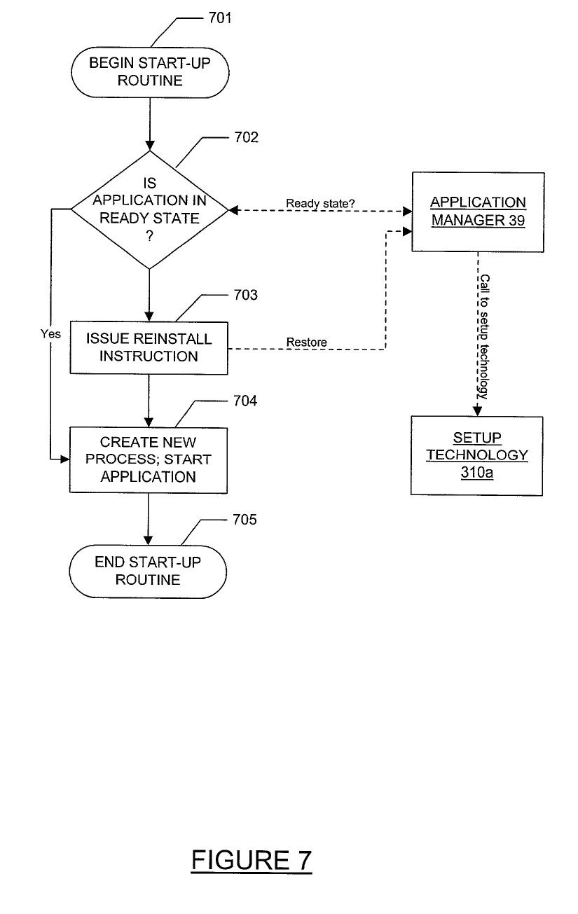

FIG. 7 is a flowchart showing the process by which an application is started when an application manager in accordance with the present invention is used. The start-up routine begins at step 701 in response to a request to start the application, such as a request from a user. Because application manager 39 may have removed some application data though downsizing, it is necessary to check each time an application is run whether the application is in its ready state (i.e., whether the data necessary to run the application is resident on the hard disk). At step 702, the start-up routine determines whether the application is in its ready state by querying the application manager. If the application is in its ready state, then the start-up routine proceeds to step 704 to create a process to run the application. If the application is not in its ready state, then application manager 39 is called upon to restore the application to its ready state. Application manager 39, in turn, calls the setup technology 310a for the application program being started, which replaces data to hard disk 27 in the manner depicted in FIG. 6. The start-up routine then proceeds to step 704 to create a process to run the application program. After the process has been created, the start-up routine terminates, and the application runs on the process created at step 704.

### EXAMPLE APPLICATION MANAGER—APPLICATION PROGRAMMING INTERFACE

The above described application manager controls access to at least four installation related operations: install; downsize; reinstall; and uninstall. Generally, data objects, such as software applications are responsible for actually performing the installation operations, while the application manager coordinates the operations.

With regard to each of the four installation operations, the application manager operates on a notify and commit procedure. This procedure requires that, prior to executing one of the installation procedures, an application must notify the application manager of the impending operation. Furthermore, after completing the installation operation, the application finalizes the operation by committing it with the application manager. This notify-then-commit procedure allows the application manager to detect installation operations that start but are never completed. Accordingly, the application manager can thereafter correct for incomplete transaction.

Software applications communicate with the application manager via an application programming interface (API) to perform the installation operations. Software applications use the API to provide information to the application and to retrieve information from the application manager. Further, software applications use the API to inform the application manager that a particular installation operation is pending or has been completed. Aspects of an API in accordance with the invention are described below.

IApplicationEntry Object

Each application that is installed on the system is associated with a unique instance of an “IapplicationEntry” object. The IApplicationEntry object is an interface into the application manager's record of an application instance. Upon installation of an application, the setup technology for the application calls CreateApplicationEntry(IApplicationEntry **), which creates a unique instance of an IApplicationEntry object. The interface provided by the IApplicationEntry instance must be used for the setup technology to apply actions to an application (i.e., install, reinstall, downsize, and uninstall). The entries in each IApplicationEntry include the following:

SetProperty( )

GetProperty( )

InitializeInstall( )

FinalizeInstall( )

InitializeDownsize( )

FinalizeDownsize( )

InitializeReInstall( )

FinalizeReInstall( )

InitializeUnInstall( )

FinalizeUnInstall( )

Abort( )

The entries in the IApplicationEntry interface are functions (e.g., InitializeInstall( ), FinalizeInstall( ), etc.), which are member methods of an IApplicationEntry instance. Whenever a setup program wishes to act on an application, it must create a properly initialized IApplicationEntry in order to do so.

In general, the IApplicationEntry interface employs a “notify-then-commit” architecture: A setup technology first declares its intent to perform an operation (e.g., to install an application) by calling an “Initialize” method; after performing the operation, the setup technology reports to the application manager that the operation was performed by calling a “Finalize” method. The notify-then-commit architecture allows the application manager to detect operations that were declared but never completed.

The methods in each instance of IApplicationEntry are described below. It should be noted that for each of the methods described below, if the method succeeds, the return value is OK. If a method fails, however, an error is returned to the calling application.

SetProperty (DWORD dwproperty, LPVOID pData, DWORD dwDataLen)

The SetProperty( ) method is used to set various properties of an application instance. A list of properties in an application instance is provided below in the Properties heading. The setup program is required to SetProperty( ) on certain properties prior to calling the Initialize . . . ( ) and Finalize . . . ( ) methods. For example, a setup program calls set property to establish a value for property APP_PROPERTY_STATE prior to calling FinalizeDownsize( ).

The SetProperty( ) method takes three parameters: dwProperty, pData, and dwDataLen. Parameter dwProperty identifies which of the application properties is being set by the call to SetProperty( ). Parameter pData is a pointer to a string which contains the value for the property that is being set. Parameter dwDataLen holds a value for the length of the pData string.

GetProperty(DWORD dwproperty, LPVOID pData, DWORD dwPropertyLen)

The GetProperty( ) method is counterpart of SetProperty( ) and is used to retrieve application properties stored within an IApplicationEntry instance. Setup programs use this method in order to retrieve setup information about an application. For example, following a call to the InitializeInstall( ) method, the setup program calls GetProperty( ) to retrieve the root path, the setup root path and the GUID assigned to the application being installed.

The GetProperty( ) method takes three parameters: dwproperty, pData, and dwDataLen. Parameter dwProperty identifies which of the application properties is being retrieved by the call to GetProperty( ). Parameter pData is a pointer to a string that will receive the value for the property is being set. Parameter dwDataLen receives a value for the length of the pData string.

ItializeInstall(void)/FinalizeInstall(void)

The InitializeInstall( ) method is called by the setup technology of an application to notify the application manager that the setup program is about to start an install operation. In order to be successful, setup programs are required to call SetProperty( ) to establish a value for the APP_PROPERTY_ESTIMATED_INSTALL_SIZE property prior to calling InitializeInstall( ). APP_PROPERTY_ESTIMATED_INSTALL_SIZE represents the amount of disk space needed to install the resources that do not already exist on the local machines, and does not include resources that already exist, such as files that may have been installed after an aborted, but partially performed, installation. Setup programs also call the SetProperty( ) method during an install operation to establish values for the following properties: APP_PROPERTY_COMPANYNAME which represents the name of the company that manufactures the application; APP_PROPERTY_SIGNATURE which represents the name of the software application being installed; and APP_PROPERTY_CATEGORY which represents the type of application being installed, e.g. whether the application is a game or financial package.

Once InitializeInstall( ) successfully returns, the setup program calls GetProperty( ) to retrieve the values of the following properties: APP_PROPERTY_GUID which represents the unique identifier that has been assigned to the application that is undergoing the install operation; APP_PROPERTY_ROOTPATH which represents a location in memory where the application should store application files; and APP_PROPERTY_SETUPROOTPATH which represents a location in memory where the application should store setup program files. The application uses the values for these properties to perform the installation.

After performing an installation, the setup program calls FinalizeInstall( ) to notify the application manager that the installation is complete. Prior to calling FinalizeInstall( ), however, the setup program sets the APP_PROPERTY_EXECUTECMDLINE property using the SetProperty( ) method. The APP_PROPERTY_DEFAULTSETUPEXECMDLINE property identifies the executable file that can be started from the command line to initiate the application's setup technology. If the application has a separate command line for initiating each of the installation operations, i.e. install, downsize, reinstall, and uninstall, each of the following respective propertties are set using the SetProperty( ) method:

APP_PROPERTY_INSTALL_CMDLINE which represents the command line that the application manager needs to call in order to request that the application implement an install operation

APP_PROPERTY_DOWNSIZE_CMDLINE which represents the command line that the application manager needs to call in order to requrest that the application perform a downsize operation;

APP_PROPERTY_REINSTALL_CMDLINE which represent the command line that the application manager needs to call in order to request that the application perform a reinstall operation; and

APP_PROPERTY_UNINSTALL_CMDLINE which represents the command line that the application manager needs to call in order to request that the application perform an uninstall operation.

InitializeDownsize(void)/FinalizeDownsize(void)

The InitializeDownsize( ) method is called to notify the application manager that an application is about to start the downsize operation. The APP_PROPERTY_GUID must be set, using the SetProperty( ) method, within the IApplicationEntry instance prior to calling InitializeDownsize( ). Calling InitializeDownsize( ) causes the application manager to change the state of the application to APP_STATE_DOWNSIZING.

The FinalizeDownsize( ) method is called once the setup program has finished actually downsizing the application. The FinalizeDownsize places the application in an APP_STATE_DOWNSIZED state.

ItializeReInstall(void)/FinalizeReInstall(void)

The InitializeReInstall( ) method is called to notify the application manager that the application setup program is starting to reinstall a downsized application to the ready state. The APP_PROPERTY_GUID and APP_PROPERTY_ESTIMATEDINSTALLKILOBYTES properties are set within the IApplicationEntry instance prior to calling InitializeReInstall( ). Calling InitializeReInstall( ) causes the application manager to change the state of the application to APP_STATE_REINSTALLING.

The FinalizeReInstall( ) method is used to committ the reinstallation process and is called once the setup program has finished reinstalling an application. Calling FinalizeReInstall places the application in an APP_STATE_READY.

ItializeUnInstall(void)/FinalizeUnInstall (void)

The InitializeUnInstall( ) method is called by the setup program in order to notify the application manager that it is about to uninstall an application. The APP_PROPERTY_GUID property is set within the IApplicationEntry instance prior to is calling InitializeUnInstall( ). Calling InitializeUnInstall( ) causes the application manager to change the state of the application to APP_STATE_UNINSTALLING.

The FinalizeUnInstall( ) method is called by the setup program to notify the application manager that the uninstallation process has been completed. Calling FinalizeUninstall causes the application manager to delete the application record from the application manager database as well as force the deletion of the setup root path and all of its contents.

Abort(void)

The Abort( ) method is used when a setup program wishes to end an action without finalizing it. Aborting any actions (i.e., InitializeInstall, InitializeReInstall, etc.) causes the application manager to revert the application state back to what it was before the action started. In the case of InitializeInstall( ), calling abort will cause the application manager to delete its record of the application.

Setup Technologies

The application manager relies on setup technologies for all actions that modify the state of an application. Therefore, whenever an application registers with the application manager, it must also register the underlying setup technology responsible for managing it.

Setup technologies are invoked by running a command line. The command line is in a format appropriate for the operating system running on the computer whose resources the application manager controls, such as the WINDOWS operating system.

The setup technology informs the application manager of the command line to perform the downsize, reinstall, and uninstall operations by calling SetProperty( ) to set the following properties:

APP_PROPERTY_DOWNSIZE_CMDLINE

APP_PROPERTY_REINSTALL_CMDLINE

APP_PROPERTY_UNINSTALL_CMDLINE

Each command line specification is separate in order to allow the flexibility of using multiple executables based on the action needed. However, the setup technology may be contained within one executable, with each defined command line containing parameters that specify which action the setup technology is to perform.

The application manager adds the following parameters to any command line specified in the properties listed above:

/guid=<{ . . . )>/action=<string>/size=<size>

where:

GUID=the GUID assigned to the action by CreateApplicationEntry( )

action=DOWNSIZE, REINSTALL, or UNINSTALL

size=disk space needed when downsize is called

The /size parameter is only used when /action=DOWNSIZE.

Properties

The following is a description of the properties used in an instance of IApplicationEntry:

APP_PROPERTY_GUID

This GUID is a unique identifier assigned by the application manager when InitializeInstall is called. The setup program should save this value since it is needed property in action calls (Initialize . . . ( )/Finalize . . . ( ) as well as AddAssociation( )/RemoveAssociation( ) and Runo).

APP_PROPERTY_ROOT_PATH

The root path value is set by calling the InitializeInstall( ) method. It indicates where a setup program should store application files.

APP_PROPERTY_SETUP_ROOT_PATH

The setup root path value is set by calling the InitializeInstall( ) method. It indicates where a setup program should store setup program files (i.e. Setup.exe, Setup.dll, etc.)

APP_PROPERTY_ESTIMATED_INSTALL_SIZE

The estimated install size represents the amount of additional disk space that a setup program will need in order to successfully install/reinstall an application. This value should be specified in Kb. This value represents additional disk, rather than total disk space, needed by the install or reinstall routine, which is significant in the case where a setup program was aborted after a partial installation. For example, if a setup program requests 300 Mb of disk space and then fails after installing 120 Mb, it should ask for 180 Mb of disk space when attempt the installation a second time. This property can only be set prior a call to InitializeInstall( ) or prior to calling InitializeReInstall( ).

APP_PROPERTY_REMOVABLE_SIZE

The removable size represents the amount of disk space (in Kb) that the removable resources of application take up on disk. This property can only be set prior a calling to FinalizeInstall( ) or prior to calling FinalizeReInstall( ).

APP_PROPERTY_NON_REMOVABLE_SIZE

The non-removable size represents the amount of disk space (in Kb) that the non-removable resources of application take up on disk. Non-removable resources are resources that cannot be recreated by the setup program once they are deleted from the local machine (e.g., saved game files, configuration files and other user-generated documents). This property can only be set prior a calling to FinalizeInstall( ) or prior to calling FinalizeReInstall( ).

APP_PROPERTY_DOWNSIZE_CMDLINE

The downsize command line value represents the command line that the application manager needs to call in order to ask an application to downsize itself. This property can only be set prior to calling FinalizeInstall( ) or FinalizeReInstall( ).

APP_PROPERTY_REINSTALL_CMDLINE

The reinstall command line value represents the command line that the application manager needs to call in order to ask an application to reinstall itself. This property can only be set prior to calling FinalizeInstall( ) or FinalizeReInstall( ).

APP_PROPERTY_UNINSTALL_CMDLINE

The uninstall command line value represents the command line that the application manager needs to call in order to ask an application to uninstall itself. This property can only be set prior to calling FinalizeInstall( ) or FinalizeReInstall( ).

APP_PROPERTY_EXECUTE_CMDLINE

The execute command line property represents the command line that the application manager needs to call in order run the application. This property can only be set prior to calling FinalizeInstall( ) or FinalizeReInstall( ).

APP_PROPERTY_STATE

This property is mainly used by setup programs in order to define what state an application is in. This helps setup programs find out about error states (i.e., failed installation, failed reinstallation, etc.). Allowable values of this property include APP_STATE_READY, APP_STATE_DOWNSIZED, and APP_STATE_DOWNSIZING. However, this property can be set subsequent to calling FinalizeDownsize( ) if a setup program wishes to advice the application manager that the application is still runable. By default, calling FinalizeDownsize( ) will cause the application manager to assign an APP_STATE_DOWNSIZED state to an application. However, if an application was downsized by reducing its application size down to a smaller installation (i.e., from large to medium), then the application would still be in an APP_STATE_READY. Setup program can call SetProperty on APP_PROPERTY_STATE with APP_STATE_READY in order to advise the application manager not to flag the application as downsized. This property can only be set prior to calling FinalizeDownsize( ), and should only be set if the downsize application is still runable (i.e., the application downsized itself down to a smaller install size).

Methods for Communicating with Applications

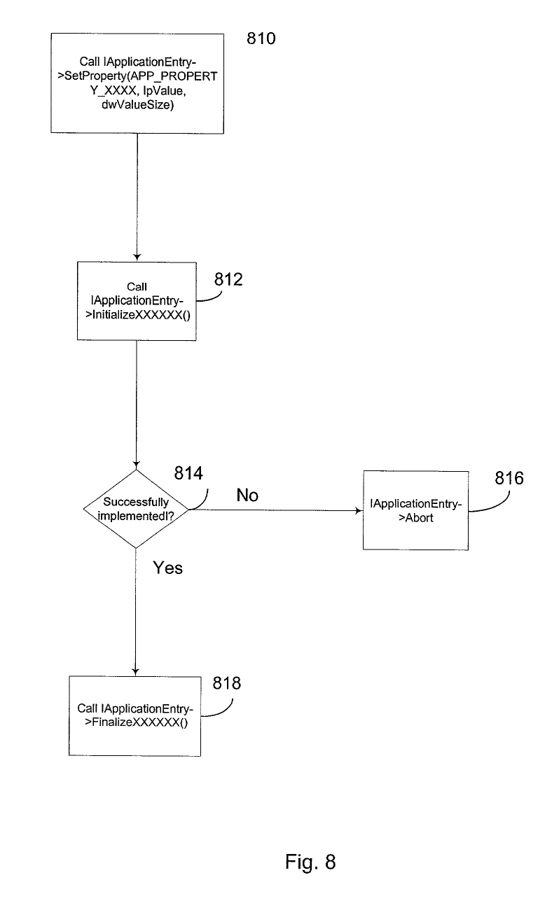

The above described API is employed by applications to communicate with the application manager. FIGS. 8 through 12 provide flow charts illustrating the process employed at the application manager for communicating with applications during installation operation.

FIG. 8 provides a flowchart of a generalized process for implementing the four application installation operations: install, downsize, reinstall, and uninstall. The process of FIG. 8 applies generally to each of these installation operations, although slight variations, which are described below, may apply to the individual operations.

Prior to implementing an installation operation, an application needs to set certain properties that are associated with an instance of the IapplicationEntry object. Accordingly, as shown at step 810, the application manager receives a call to the SetProperty( ) method from the application. The SetProperty( ) method initializes application properties associated with the IapplicationEntry object.

After values have been established for the necessary properties, an application can initialize the installation operation. The initialize procedure is equivalent to notifying the application manager that the application is undertaking to perform a particular installation operation. Accordingly, at step 812, a call to one of the initialize methods, InitializeInstall( ), InitializeReinstall( ), InitializeUninstall( ), or InitializeDownsize( ) is received by the application manager. The initialize call notifies the application manager of the impending application installation.

If the application did not successfully complete the installation operation (step 814), at step 816, a call to the Abort( ) method of the IapplicationEntry object is received from the application.

If, however, the application successfully completed the installation operation, at step 818, a call to one of the finalize methods FinalizeInstall( ), FinalizeReinstall( ), FinalizeUninstall( ), or FinalizeDownsize( ) is received by the application manager. The finalize method operates to commit to the application manager that the particular installation operation has been completed.

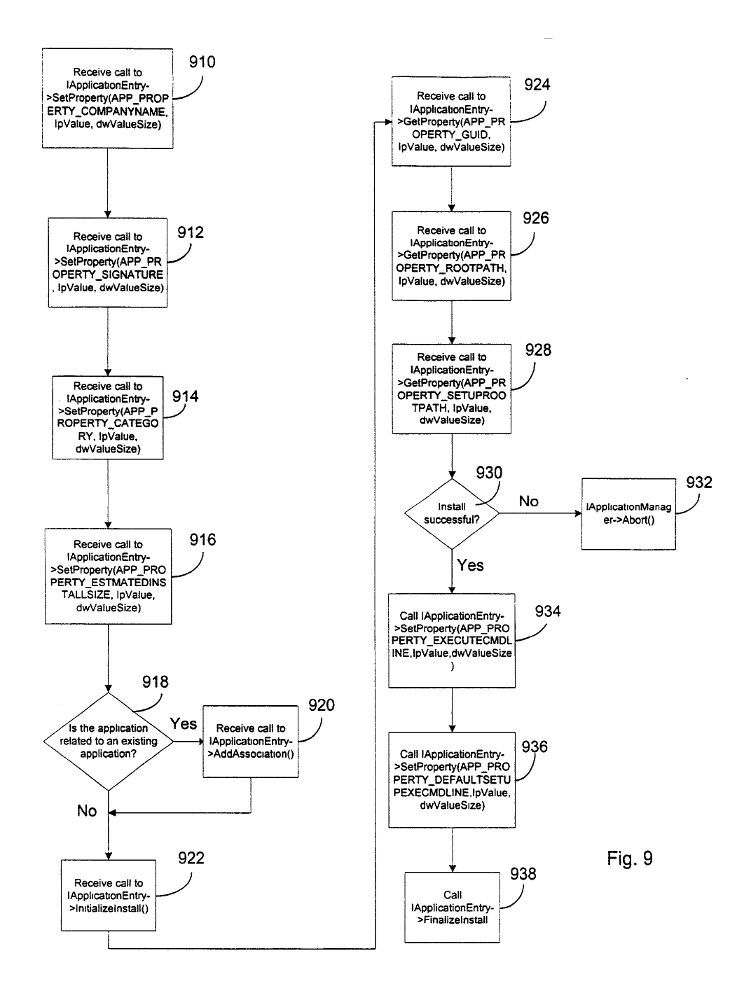

FIG. 9 provides a detailed view of the process implemented by the application manager for communicating with an application during an application install operation. Prior to performing an install operation, it is necessary for an application to establish values for a series of properties associated with the IapplicationEntry object. Thus, as shown, at step 910, a call to method SetProperty( ) is received to establish a value for the APP_PROPERTY_COMPANYNAME property of the IapplicationEntry object. At step 912, a call to method SetProperty( ) is received to set a value for the APP_PROPERTY_SIGNATURE property. At step 914, a call to SetProperty( ) is received to set a value for the APP_PROPERTY_CATEGORY property. At step 916, a call to method SetProperty( ) is received to establish a value for the APP_PROPERTY_ESTIMATEDINSTALLSIZE property.

After values have been established for the relevant object properties, it is necessary to account for any associations that the particular application may have, i.e. whether or not the application that is being installed is related to an existing application. If at step 918, the application is related to an existing application, at step 920, a call is received to the AddAssociation( ) method.

After values have been set for the relevant IapplicationEntry properties and the necessary associations have been established, the application must notify the application manager of an impending installation. Accordingly, at step 922, a call to InitializeInstall( ) is received by the application manager.

The application will require access to information from the application manager in order to implement the install operation. Accordingly, at step 924, a call to the GetProperty( ) method requesting a value for the APP_PROPERTY_GUID property is received by the application manager. At step 926, a call to GetProperty( ) requesting a value for the APP_PROPERTY_ROOTPATH property is received. At step 928, a call to GetProperty( ) is received to retrieve a value for the APP_PROPERTY_SETUPROOTPATH property. Using the values obtained for these object properties, the application can install itself.

If the install operation is not successful (step 930), at step 932, a call to the Abort( ) method is received by the application manager.

If the install operation is successful, however, the application needs to establish values for several properties with the application manager prior to finalizing the installation. According, at step 934, the application makes a call to the SetProperty( ) method to establish a value for the APP_PROPERTY_EXECUTABLECMDL property. At step 936, a call to the SetProperty( ) method is received to establish a value for the APP_PROPERTY_DEFAULTSETUPEXECMDLINE property.

The install operation is completed when, at step 938, a call to the FinalizeInstall( ) method is received at the application manager.

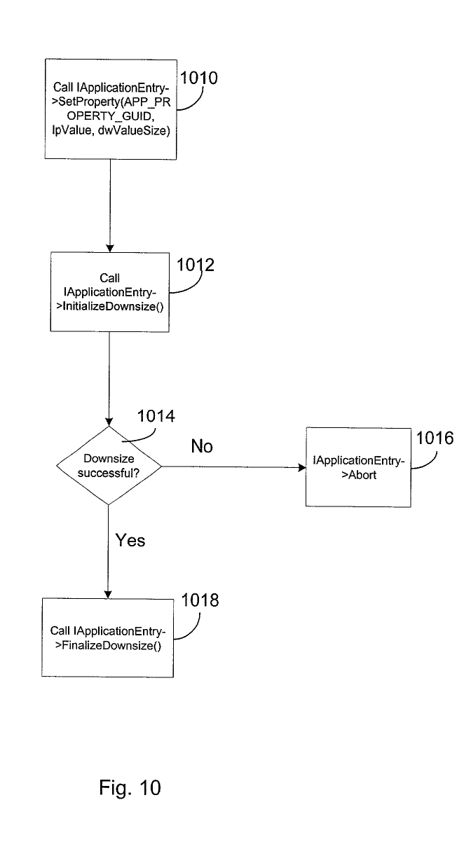

FIG. 10 provides a detailed view of the process implemented by the application manager for communicating with an application during an application downsize operation. Prior to performing the downsize operation, it is necessary for an application to establish values for the APP_PROPERTY_GUID property associated with an instance of IapplicationEntry object. Thus, as shown, at step 1010, a call to method SetProperty( ) is received to establish a value for the APP_PROPERTY_GUID property.

After establishing this value, the application must is notify the application manager of the impending downsize. Accordingly, at step 1012, a call to the InitializeDownSize( ) method is received by the application manager from the application.

If the downsize operation is not successfully implemented by the application (step 1014), at step 1016, a call to the Abort( ) method is received by the application manager.

If the downsize operation is successful, however, the application needs to commit the downsize operation by informing the application manager that the operation has been completed. Accordingly, at step 1018, a call to the FinalizeInstall( ) method is received at the application manager.

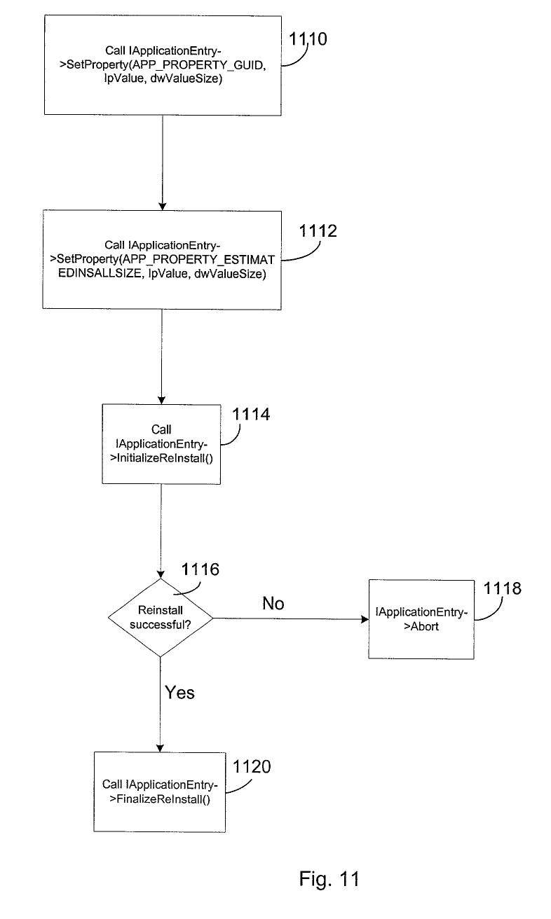

FIG. 11 provides a detailed view of the process implemented by the application manager for communicating with an application during an application reinstall operation. Prior to performing the reinstall operation, it is necessary for an application to establish values for the APP_PROPERTY_GUID property and APP_PROPERTY_ESTIMATEDINSTALLSIZE property associated with an instance of IapplicationEntry object. Thus, as shown, at step 1110, a call to SetProperty( ) method is received to establish a value for the APP_PROPERTY_GUID property. At step 1112, another call to SetProperty( ) method is received to establish a is value for the APP_PROPERTY_ESTIMATEDINSTALLSIZE property.

After establishing these values, the application must notify the application manager of the impending reinstall operation. Accordingly, at step 1114, a call to the InitializeReInstall( ) method is received by the application manager from the application.

If the reinstall operation is not successfully implemented by the application (step 1116), at step 1118, a call to the Abort( ) method is received by the application manager.

If the reinstall operation is successful, however, the application needs to commit the reinstall operation by informing the application manager that the operation has been completed. Accordingly, at step 1120, a call to the FinalizeReInstall( ) method is received at the application manager.

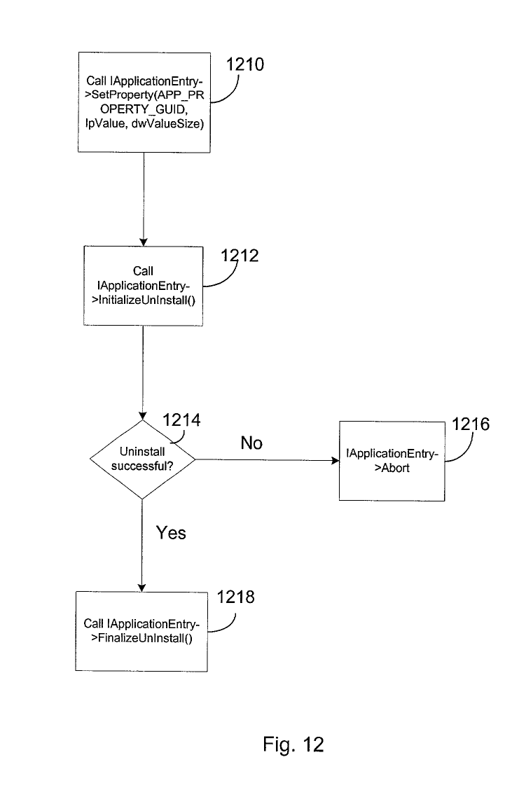

FIG. 12 provides a detailed view of the process implemented by the application manager for communicating with an application during an application uninstall operation. Prior to performing the uninstall operation, it is necessary for an application to establish values for the APP_PROPERTY_GUID property associated with an instance of IapplicationEntry object. Thus, as shown, at step 1210, a call to method SetProperty( ) is received to establish a value for the APP_PROPERTY_GUID property.

After establishing this value, the application must notify the application manager of the impending uninstall operation. Accordingly, at step 1212, a call to the InitializeUninstall( ) method is received by the application manager from the application.

If the uninstall operation is not successfully implemented by the application (step 1214), at step 1216, a call to the abort method is received by the application manager.

If the uninstall operation is successful, however, the application needs to commit the reinstall operation by informing the application manager that the operation has been completed. Accordingly, at step 1218, a call to the FinalizeUnInstall( ) method is received at the application manager.

Thus, an application manager for managing the installation of data objects, and in particular, software applications has been disclosed. An API is provided for communicating between the application manager and applications. The application manager and API provide a means for identifying shortages in memory and for freeing memory, preferably by removing underutilized applications, so that new applications can be installed.

An application manager and API in accordance with the invention may be applied to many different areas and results in a great many advantages. For example, the application manager provides a seamless installation process that is much more user friendly than previous systems. The application manager keeps track of disk space and can identify which applications are the best candidates to be removed. The application manager can therefore execute installations with minimal or no user interaction such as, for example, prompting a user as to which disk on which to install an application. The greatly simplified installation procedures isolate users from one of the most tedious of computing related operations. Indeed, the application manager has the effect of making computing as simple and straight-forward as using other types of electronics equipment such as televisions and cassette recorders. These advantages are available on all types of computing systems including personal computers, game consoles, set-top boxes, web companions, and personal digital assistants.

Furthermore, the functionality provided by the application manager might be integrated with other facilities such as a disk cleanup utility. A disk cleanup utility provides an integrated means for cleaning-up space from old applications. If a user needs to make disk space available, he or she would have the opportunity to downsize applications that have not been used for an extended period of time. As a consequence of the benefits provided by the invention, users do not need to be involved in deciding how the downsize operation occurs.

An application manager and API in accordance with the present invention also promises to simplify the OEM manufacturing process. For example, OEMs can use the application manager to pre-populate hard disks with downsized applications so as to reduce the amount of time spent installing applications. When an end-user attempts to use a downsized application, the application manager can complete the installation process by instructing the user to insert the appropriate CD. Loading applications in a downsized state results in the applications taking up less disk space and therefore allows for OEMs to install more applications, in the downsized state, of course, than might otherwise be installed.

An application manager and API in accordance with the invention also benefits publishers of software by lengthening the period which an application may appear on a desktop. In existing systems, it is often necessary to completely uninstall an application in order to free disk space on a system. Once the application is uninstalled, the application is typically no longer shown on the available menus or desk top. In contrast, an application manager in accordance with the invention, which provides a downsize operation, allows for partially uninstalling applications. While an application is in the downsized state, it still appears as being available to be used. Thus, application publishers have a presence on the system even after their applications have been partially uninstalled.

It is noted that the foregoing examples have been provided merely for the purpose of explanation and are in no way to be construed as limiting of the present invention. Particularly, while the invention has been described with reference to an application manager managing space on a hard disk in response to requests to run or install applications, it will be appreciated by those skilled in the art that the invention can be applied to various types of computer memory occupied by various types of data objects. For example, the invention could be used to manage files in a database, or data residing in volatile memory. Furthermore, the act of freeing up space in memory need not be performed in response to requests for space, but may arise in numerous contexts, such as where a computer system uses idle time to clear its memory resources. Likewise, the restoration of data to the managed medium need not be performed in response to a specific request for a data object, such as an attempt to run an application, but could arise in numerous contexts, such as where a system uses its idle time to keep a particular memory resource filled, or where the system employs a scheme to predict which downsized data objects will be called for in the future.

Those skilled in the art understand that computer readable instructions for performing the above described processes can be generated and stored on a computer readable medium such as a floppy disk or CD-ROM. Further, a computer such as that described with reference to FIG. 1 may be arranged with other similarly equipped computers in a network, and each computer may be loaded with computer readable instructions for performing the above described processes. Specifically, referring to FIG. 1, microprocessor 21 may be programmed to operate in accordance with the above described processes.

While the invention has been described with reference to preferred embodiments, it is understood that the words which have been used herein are words of description and illustration, rather than words of limitations. Although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

What is claimed is:

1. In a system for managing application installation operations, a method of communicating with an application, comprising:
receiving from the application a call to set a property related to performing an application installation operation;
receiving from the application a call to initialize an application installation operation; and
receiving from the application a call to finalize the application installation operation.

2. The method of claim 1, wherein said application installation operation is at least one of the following: install, downsize, reinstall, uninstall.

3. The method of claim 1, further comprising, if the application installation operation is not executed successfully by the application, receiving a call to abort the application installation operation.

4. The method of claim 1, wherein said application installation operation is install, said call to initialize the application installation operation is InitializeInstall, and said call to finalize the application installation operation is FinalizeInstall.

5. The method of claim 1, wherein said application installation operation is downsize, said call to initialize the application installation operation is InitializeDownsize, and said call to finalize the application installation operation is FinalizeDownsize.

6. The method of claim 1, wherein said application installation operation is reinstall, said call to initialize the application installation operation is InitializeReInstall, and said call to finalize the application installation operation is FinalizeReInstall.

7. The method of claim 1, wherein said application installation operation is uninstall, said call to initialize the application installation operation is InitializeUnInstall, and said call to finalize the application installation operation is FinalizeUnInstall.

8. The method of claim 1, further comprising receiving a call from the application to get a property related to performing an application installation operation.

9. The method of claim 1, wherein said call to set a property is SetProperty.

10. A computer readable medium having instructions thereon for performing the method of claim 1.

11. In a system for managing application installation operations, a method of communicating with an application, comprising:
receiving from the application a call to set a property related to performing an application install operation;
receiving from the application a call to initialize the application install operation; and
receiving from the application a call to finalize the application install operation.

12. The method of claim 11, wherein said call to set a property is SetProperty.

13. The method of claim 12, wherein said call to SetProperty includes a parameter identifying APP_PROPERTY_COMPANYNAME as the property that is being set.

14. The method of claim 13, wherein said call to SetProperty further includes a parameter for pointing to a string identifying a company.

15. The method of claim 12, wherein said call to initialize the application install operation is InitializeInstall.

16. The method of claim 12, wherein said call to finalize the application install operation is FinalizeInstall.

17. The method of claim 12, further comprising if the application install is not executed successfully by the application, receiving a call to abort the application install operation.

18. A computer readable medium having instructions thereon for performing the steps recited in claim 12.

19. The method of claim 12, further comprising the following:
receiving a call to SetProperty having a parameter identifying APP_PROPERTY_SIGNATURE as the property that is being set;
receiving a call to SetProperty having a parameter identifying APP_PROPERTY_CATEGORY as the property that is being set; and
receiving a call to SetProperty having a parameter identifying APP_PROPERTY_ESTIMATEDINSTALLSIZE as the property that is being set.

20. The method of claim 12, further comprising receiving from the application a call to retrieve an application property.

21. The method of claim 20, wherein said call to retrieve an application property is GetProperty.

22. The method of claim 21, wherein said call to GetProperty has a parameter identifying APP_PROPERTY_GUID as the application property being retrieved.

23. The method of claim 21, wherein said call to GetProperty has a parameter for pointing to a string containing a GUID value identifying the application that is the object of the install operation.

24. The method of claim 22, further comprising the following:
receiving a call to GetProperty having a parameter identifying APP_PROPERTY_ROOTPATH as the application property that is being retrieved; and
receiving a call to GetProperty having a parameter identifying APP_PROPERTY_SETROOTPATH as the application property that is being retrieved.

25. The method of claim 12, further comprising the following:
receiving a call to SetProperty having a parameter identifying APP_PROPERTY_EXECUTECMDLINE as the application property that is being set; and
receiving a call to SetProperty having a parameter identifying APP_PROPERTY_DEFAULTSETUPEXECMDLINE as the application property that is being set.

26. A computer readable medium having instructions thereon for performing the method of claim 12.

27. In a system for managing application installation operations, a method of communicating with an application, comprising:
receiving from the application a call to set a property related to performing an application uninstall operation;
receiving from the application a call to initialize the application uninstall operation; and
receiving from the application a call to finalize the application uninstall operation.

28. The method of claim 27, wherein said call to set a property is SetProperty.

29. The method of claim 28, wherein said call to SetProperty has a parameter identifying APP_PROPERTY_GUID as the application property that is being set.

30. The method of claim 29, wherein said call to SetProperty has a further parameter for pointing to a GUID for identifying the application that is the object of the uninstall operation.

31. The method of claim 27, wherein said call to initialize the application uninstall operation is InitializeUnInstall.

32. The method of claim 27, wherein said call to finalize the application uninstall operation is FinalizeUnInstall.

33. The method of claim 27, further comprising if the application uninstall is not successfully executed by the application, receiving a call to abort the application uninstall operation.

34. A computer readable medium having instructions thereon for performing the steps recited in claim 27.

35. In a system for managing application installation operations, a method of communicating with an application, comprising:
receiving from the application a call to set a property related to performing an application downsize operation;
receiving from the application a call to initialize the application downsize operation; and
receiving from the application a call to finalize the application downsize operation.

36. The method of claim 35, wherein said call to set a property is SetProperty.

37. The method of claim 36, wherein said call to SetProperty has a parameter identifying application property APP_PROPERTY_GUID as the property being set.

38. The method of claim 37, wherein said call to SetProperty has a further parameter for pointing to a GUID for identifying the application that is the object of the downsize operation.

39. The method of claim 35, wherein said call to initialize the application downsize operation is InitializeUnInstall.

40. The method of claim 35, wherein said call to finalize the application downsize operation is FinalizeUnInstall.

41. The method of claim 35, further comprising if the application uninstall is not successfully executed by the application, receiving a call to abort the application downsize operation.

42. A computer readable medium having instructions thereon for performing the steps recited in claim 35.

43. In a system for managing application installation operations, a method of communicating with an application, comprising:
receiving from the application a call to set a property related to performing an application reinstall operation;
receiving from the application a call to initialize the application reinstall operation; and
receiving from the application a call to finalize the application reinstall operation.

44. The method of claim 43, wherein said call to set a property is SetProperty.

45. The method of claim 44, wherein said call to SetProperty has a parameter identifying APP_PROPERTY_GUID as the application property that is being set.

46. The method of claim 45, wherein said call to SetProperty has a further parameter for pointing to a GUID for identifying the application that is the object of the reinstall operation.

47. The method of claim 45 further comprising receiving a call to SetProperty having a parameter identifying APP_PROPERTY_ESTIMATEDINSTALLSIZE as the application property that is being set.

48. The method of claim 43, wherein said call to initialize the application reinstall operation is InitializeReInstall.

49. The method of claim 43, wherein said call to finalize the application reinstall operation is FinalizeReInstall.

50. The method of claim 43, further comprising if the application reinstall is not successfully executed by the application, receiving a call to abort the application reinstall operation.

51. A computer readable medium having instructions thereon for performing the steps recited in claim 43.

52. A system for managing application installation operations, comprising:
a computing device operable to read programmed instructions; and
programmed instructions for performing a method of communicating with an application, comprising:
receiving from the application a call to set a property related to performing an application installation operation;
receiving from the application a call to initialize an application installation operation; and
receiving from the application a call to finalize the application installation operation.
